(19) United States
(12) Patent Application Publication
(10) Pub. No.: US 2026/0199909 A1
(43) Pub. Date: Jul. 16, 2026

(54) Cyclonic Separator System with a Bypass Conduit

(71) Applicants: Helmi Al-Jamal, Richmond, TX (US); Francois Martin, Cypress, TX (US)

(72) Inventors: Helmi Al-Jamal, Richmond, TX (US); Francois Martin, Cypress, TX (US)

(21) Appl. No.: 19/387,955

(22) Filed: Nov. 13, 2025

Related U.S. Application Data
(63) Continuation-in-part of application No. 19/236,006, filed on Jun. 12, 2025.
(60) Provisional application No. 63/744,171, filed on Jan. 10, 2025.

(51) Int. Cl. B04C 5/26; B04C 5/30

(52) U.S. Cl. CPC B04C 5/26; B04C 5/30

(57) ABSTRACT

The cyclonic separator system with a bypass conduit described herein includes a primary separator for initial separation of a process stream into a filtered stream and a primary sand stream, and a secondary separator that receives the primary sand stream for further separation and disposal. A bypass conduit conveys a bypass stream from the secondary separator to the primary separator. The bypass conduit has an inlet within the secondary separator and an outlet that can selectively discharge within the primary separator or merge with the incoming process stream. In some embodiments, a splitting valve on the bypass conduit directs the bypass stream based on pressure differentials, mitigating backflow. This configuration aims to improve separation efficiency and operability of the separation system.

### CROSS-REFERENCE TO RELATED APPLICATIONS

This application claims benefit of priority from U.S. Provisional Application Ser. No. 63/744,171, filed Jan. 10, 2025, the entire contents of which are hereby incorporated by reference.

This application claims benefit of priority from U.S. Non-Provisional application Ser. No. 19/236,006, filed Jun. 12, 2025, the entire contents of which are hereby incorporated by reference.

### BACKGROUND

### Field of the Invention

This disclosure relates to bypass conduits introduced between cyclonic separator's enclosures.

### Description of the Related Art

Oil and gas are produced from underground reservoirs after drilling a hole in the ground whether on land or at the bottom of ocean. The produced oil and/or gas contain various constituent materials including sand particles. These sand particles need to be filtered out from the produced stream prior it is sent to further processing or to customers because the presence of sand particles damages downstream equipment if not filtered out. Desanders are commonly used equipment in the Oil and Gas industry to filter out these sand particles using cyclonic separators. These cyclonic separators function by pushing the sand particles to the walls of the cyclone because of the relatively high inertia of the sand. Circulation within the cyclonic separator is promoted by inserting the process stream through the inlet at a tangential angle to the inside wall of the cyclonic separator. The sand then falls downward due to gravity, and the filtered stream exits upward through the center of the cyclone because of pressure depression.

The oil and gas industry has struggled to develop desanding technologies that are effective at filtering sand from a process stream consisting of oil and gas over a broad range of production flowrate scenarios. For example, existing cyclonic separators which operate near 100% efficiency at a low production flow rate are unlikely to operate efficiently at a high production flow rates. This inconsistency in efficiency forces the industry to operate multiple versions or stages of desander cyclones depending on the production conditions.

Therefore, developing a desander cyclone that operates well at different flowrates and at different phase fractions of produced oil and gas would simplify the filtering process and reduce time and effort in switching between different cyclones in the production field.

Furthermore, oil and gas facility operators prefer to operate cyclonic separators with a closed disposal port. This is because if the disposal port is left opened, the filtered sand exiting through the disposal port will have unacceptably high levels of oil and/or gas, which is considered a safety hazard. For that reason, operators typically operate cyclonic separators with the disposal port closed, thereby causing the cyclonic separator to operate intermittently.

In addition, empirical experience shows that the sand-collecting drum below the cyclonic separator often develops a high-pressure field that, in many conditions, prevents some sand particles from being deposited down into the sand-collecting drum. This can cause sand particles to be re-mixed into the fluid within the cyclonic separator, ultimately causing the sand to be entrained in the filtered stream which exits the filtered outlet through the top of the cyclonic separator.

Therefore, developing a cyclonic separation which mitigates against a high-pressure environment developing within the sand-collecting drum would be useful because that would improve the performance of the cyclonic separator system.

### SUMMARY

The disclosure concerns a cyclonic separator system with a bypass conduit, also called the “separation system,” herein. The separation system separates constituent materials from a process stream such as oil, gas and other mining process streams. More specifically, the separation system filters gas from a process stream which may contain oil, water, gas, particulate matter, or some combination thereof. The separation system comprises a primary separator, a secondary separator, and a bypass conduit which recirculates a bypass stream from the secondary separator to the primary separator.

The process stream enters the primary separator and induces a rotational flow within the primary separator enclosure. Due to its higher density, the particulate matter, called “sand” herein, tends to collect towards the lateral walls of the primary enclosure, where it falls downwards. Similarly, the medium-density water and oil tend to collect towards the lateral walls of the primary enclosure where they fall downward too. The less-dense gas tends to collect towards the center of the enclosure where it flows up and out of the primary separator. The heavier constituents collect towards the lower end of the separator before exiting the primary outlet of the primary separator. The stream which exits the bottom of the primary separator, called the primary sand stream, is conveyed to a secondary separator.

The secondary separator receives the primary sand stream, and the sand collects towards the lower end of the secondary separator. The fluid constituents in the primary sand stream collect within the secondary separator. The secondary separator has a bypass conduit which is configured to convey a bypass stream from the secondary separator to the primary separator. In a first embodiment of the separator system the bypass stream is conveyed directly into the primary separator enclosure. In a second embodiment, the bypass stream is conveyed into the process stream before entering the primary separator enclosure. In a third embodiment, the bypass conduit has an interior bypass branch and an exterior bypass branch which are configured to convey the bypass stream into the primary enclosure or the process stream, depending on the characteristics of the process stream or the desired operating conditions of the separator system.

The bypass conduit may help reduce the developed pressure in the secondary separator. One purpose of the bypass conduit is to create a secondary pathway to push the traces of oil or gas constituents present in the secondary separator back to the filtered outlet utilizing the pressure difference between the secondary separator and the cyclonic core below the filtered outlet. The cyclonic core below the filtered outlet tends to have the lowest pressure within the interior of the primary separator.

In the second and third embodiments, fine sand particles that may be part of the bypass stream, may be added to the process stream and recirculated through the primary separator. One advantage of the first embodiment over the second embodiment may be that the differential pressure across the bypass conduit in the first embodiment may be larger than that in secondary embodiment because the static pressure at the bypass outlet may be lower than that at the bypass inlet.

### BRIEF DESCRIPTION OF THE DRAWINGS

Other features, combinations, and embodiments will be appreciated by one having the ordinary level of skill in the art of cyclonic separation systems and accessories upon a thorough review of the following details and descriptions, particularly when reviewed in conjunction with the drawings, wherein:

FIG. 1A shows a perspective view of the separation system in accordance with a first illustrated embodiment;

FIG. 1B shows a side view of the separation system in accordance with a first illustrated embodiment;

FIG. 1C shows a back view of the separation system in accordance with a first illustrated embodiment;

FIG. 1D shows a side sectional view of the separation system in accordance with a first illustrated embodiment;

FIG. 1E shows a front sectional view of the separation system in accordance with a first illustrated embodiment;

FIG. 2A shows a perspective view of the separation system in accordance with a second illustrated embodiment;

FIG. 2B shows a side view of the separation system in accordance with a second illustrated embodiment;

FIG. 2C shows a back view of the separation system in accordance with a second illustrated embodiment;

FIG. 2D shows a side sectional view of the separation system in accordance with a second illustrated embodiment;

FIG. 2E shows a front sectional view of the separation system in accordance with a second illustrated embodiment;

FIG. 3A shows a perspective view of the separation system in accordance with a third illustrated embodiment;

FIG. 3B shows a side view of the separation system in accordance with a third illustrated embodiment;

FIG. 3C shows a back view of the separation system in accordance with a third illustrated embodiment;

FIG. 3D shows a side sectional view of the separation system in accordance with a third illustrated embodiment; and

FIG. 3E shows a front sectional view of the separation system in accordance with a third illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, reference numbers are provided in the drawings for illustrating certain features of embodiments. Where distinct figures of the drawings utilize a shared reference number, it can be appreciated that the feature corresponding to the shared reference number is the same or similar, perhaps observed from a different view, or observed with respect to a different embodiment deploying the same or similar feature.

Unless explicitly defined herein, terms are to be construed in accordance with the plain and ordinary meaning as would be appreciated by one having skill in the art.

### General Description of Embodiments The sand separation system with a bypass conduit comprises a primary separator, a secondary separator, and a bypass conduit.

### Primary Separator

In some embodiments, the primary separator comprises a primary enclosure within which particulates are filtered from the tangentially entering process stream by the developed rotational circulation as a result of their high inertia. The filtered stream exits the top of the primary enclosure through the filtered outlet while the separated primary sand stream and heavy constituents exit the bottom of the primary enclosure through the primary outlet towards the secondary separator.

In some embodiments, the separation system may further comprise an isolation shroud. The isolation shroud may be attached to the upper end of the primary enclosure around the filtered outlet. The isolation shroud may have a bottom opening where the filtered stream enters the isolation shroud. In some embodiments, the purpose of the isolation shroud is to partially isolate the bypass stream from the process stream entering the primary enclosure through the primary inlet.

### Secondary Separator

In some embodiments, the secondary separator comprises a secondary enclosure that receives the primary sand stream from the primary separator to settle sand at its bottom for disposal through a disposal port located at the bottom end of the secondary separator.

### Bypass Conduit

The bypass conduit is configured to convey a bypass stream from the secondary enclosure, where the bypass inlet is disposed, towards the primary enclosure, where the bypass outlet is disposed within it or through merging with the process stream. The convey of the bypass stream is driven by the pressure drop from the bypass inlet towards the bypass outlet to remove traces of oil or gas within the primary sand stream inside the secondary enclosure rather than being disposed through the disposal port.

Another benefit of the bypass conduit is that it may lower the pressure inside the secondary separator because of a suction effect generated by the bypass pipe which may help drive sand downwards from the primary separator to the secondary separator.

### Splitting Valve

In some embodiments, the bypass conduit comprises a splitting valve, an interior bypass branch with its outlet disposed inside the primary enclosure, and an exterior bypass branch with its outlet merging with the primary stream inlet. The splitting valve directs the bypass stream coming from the bypass inlet towards any of the branches. The splitting valve directs the bypass stream to the interior bypass branch when the pressure in the primary inlet is higher than the pressure at the bypass inlet. The splitting valve directs the bypass stream to the exterior bypass branch when the pressure in the primary inlet is lower than the pressure at the bypass inlet.

### Primary Sand Conduit

In some embodiments, the separation system may further comprise a primary sand conduit. The primary sand conduit is configured to receive the primary sand stream from the primary outlet and to convey the primary sand stream into the secondary enclosure and to dispose it near the lateral wall of the secondary separator at a level below the bypass inlet.

The primary sand conduit's outlet is oriented at an angle.

### Inventory of Streams

Typically, the process stream entering will be some mixture of oil, gas, water, sand, other fluid constituents or some combination thereof. The filtered stream exiting the primary separator is intended to be primarily gas, however as with most separation technology, the separation process is not 100% efficient. The filtered stream may still contain trace amounts of oil, gas, sand, other fluid constituents or some combination thereof, in addition to gas.

Similarly, the primary sand stream exiting the primary enclosure is intended to be primarily sand, with water, oil, or heavy fluid constituents. However, in practice the primary sand stream may be a mixture of oil, gas, water, sand, other fluid constituents or some combination thereof.

Similarly, the disposal stream is intended to be primarily sand, with water, oil and heavy fluid constituents. However, in practice the disposal stream may be a mixture of oil, gas, water, sand or some combination thereof.

The bypass stream is intended to recirculate gas from the secondary separator back to the primary separator. However, in practice the bypass stream may be a mixture of oil, gas, water, trace amounts of sand, other fluid constituents or some combination thereof.

### Primary Embodiment

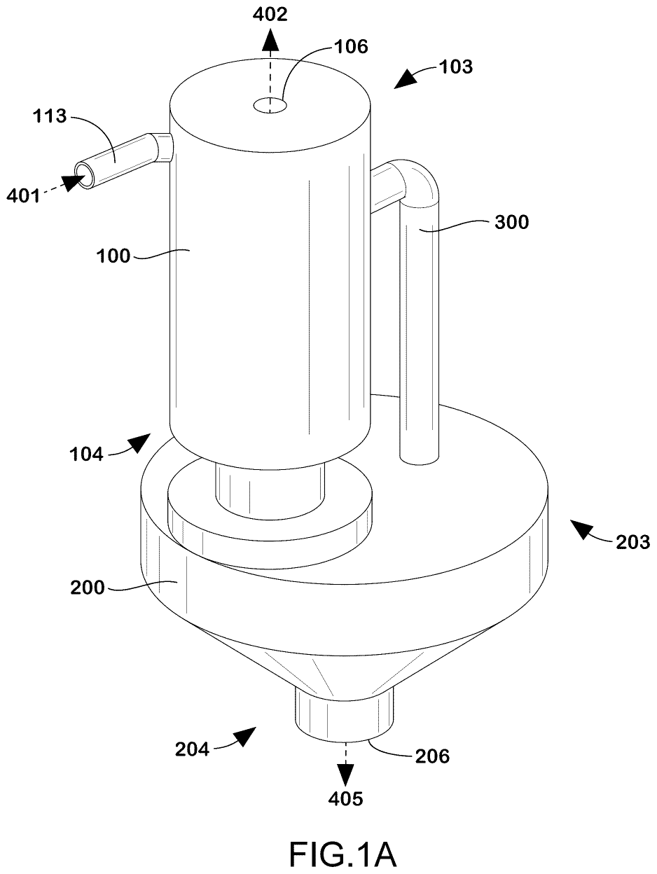

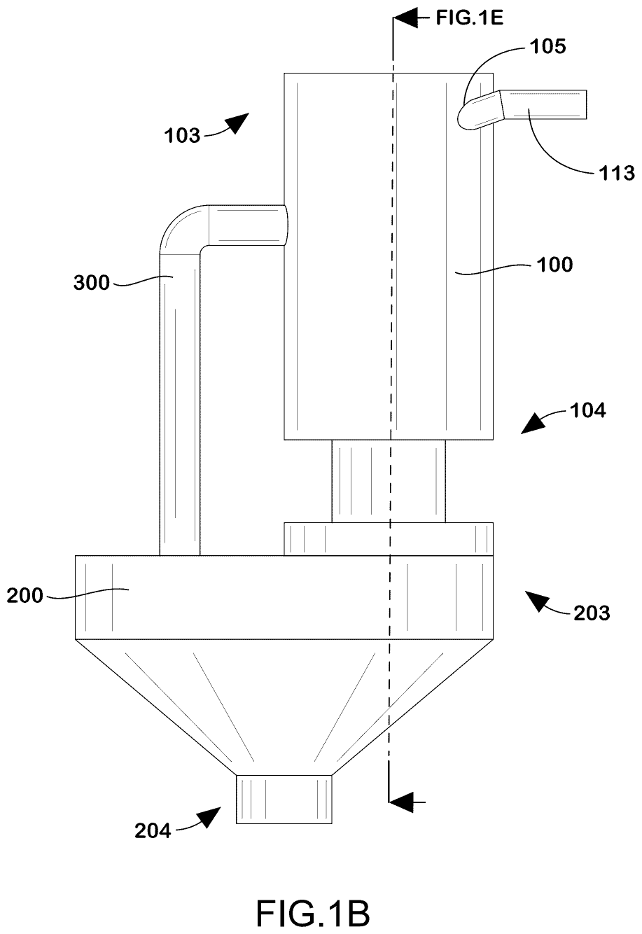

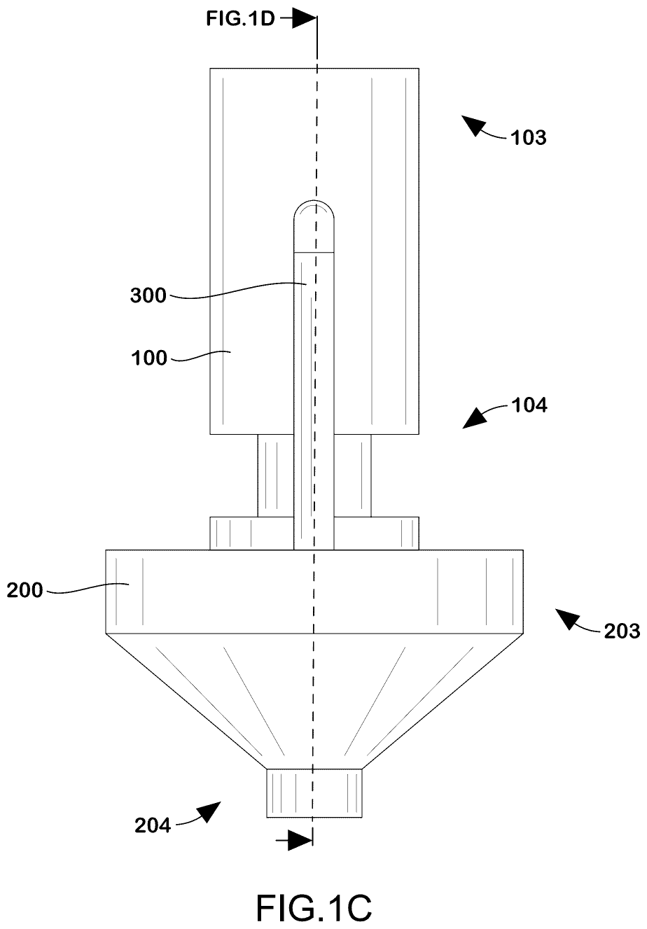

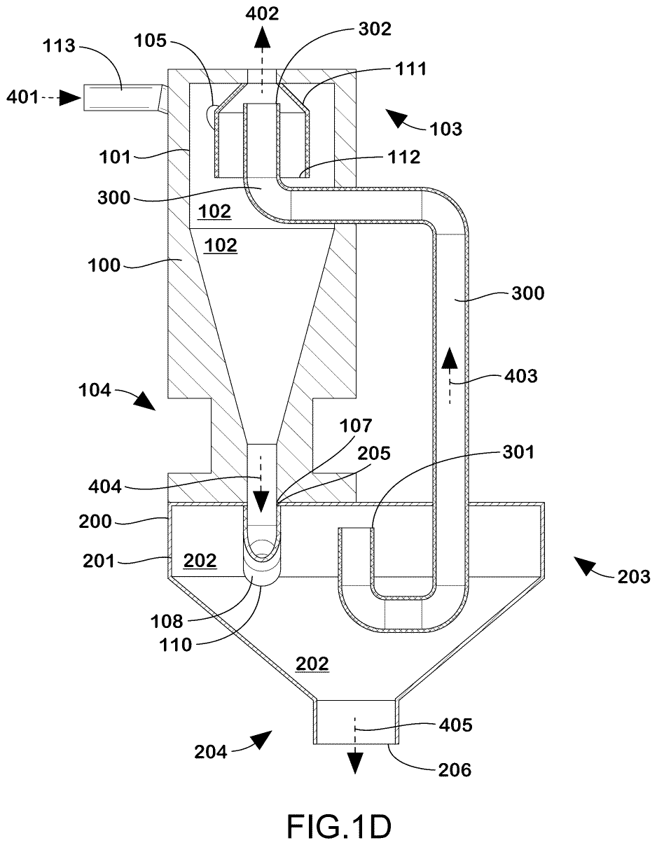

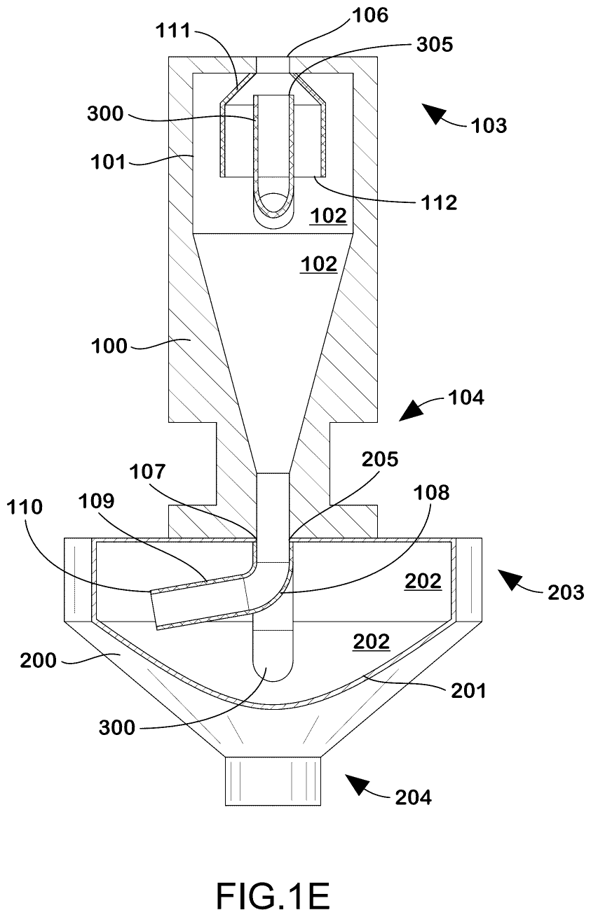

FIG. 1A through FIG. 1E depict a first illustrated embodiment of the separation system where the bypass conduit (300) leads into the primary separator (100). The process stream (401) is conveyed through the process stream conduit (113) and enters the primary enclosure (101) within the primary separator through the primary inlet (105). As shown in FIG. 1D and FIG. 1E, the primary enclosure is bounded by an upper end (103), a lower end (104), and a lateral wall (102). The filtered outlet (106) is shown disposed through the upper end of the primary enclosure. An isolation shroud (111) is shown around the filtered outlet. The isolation shroud has a bottom opening (112) which is open to the primary enclosure. The filtered stream (402) is conveyed upwards through the isolation shroud before exiting the primary enclosure through the filtered outlet.

The primary sand stream (404) passes from the primary separator (100) to the secondary separator (200). The primary outlet (107) is shown disposed through the lower end (104) of the primary enclosure (101). The secondary separator is bounded by an upper end (203) a lower end (204) and a lateral wall (202). The secondary enclosure (201) has a secondary inlet (205) disposed through the upper end (203) of the secondary enclosure. The first illustrated embodiment has a primary sand conduit (108) downstream of the secondary inlet. The primary outlet segment (109) and primary sand conduit outlet (110) are also identified in FIG. 1D and FIG. 1E. In this embodiment, the primary outlet and the secondary inlet are adjacent to each other, but other embodiments where they are not adjacent are contemplated. The disposal stream (405) exits disposal port (206) through the bottom end of the secondary enclosure.

The bypass inlet (301) of the bypass conduit (300) is disposed within the secondary separator. The bypass outlet (302) is shown disposed within the primary separator. In this embodiment, the bypass outlet passes through the bottom opening (112) of the isolation shroud and is disposed within the isolation shroud. The bypass stream (403) is conveyed from the secondary separator (200) to the primary separator (100) through the bypass conduit.

### Secondary Embodiment

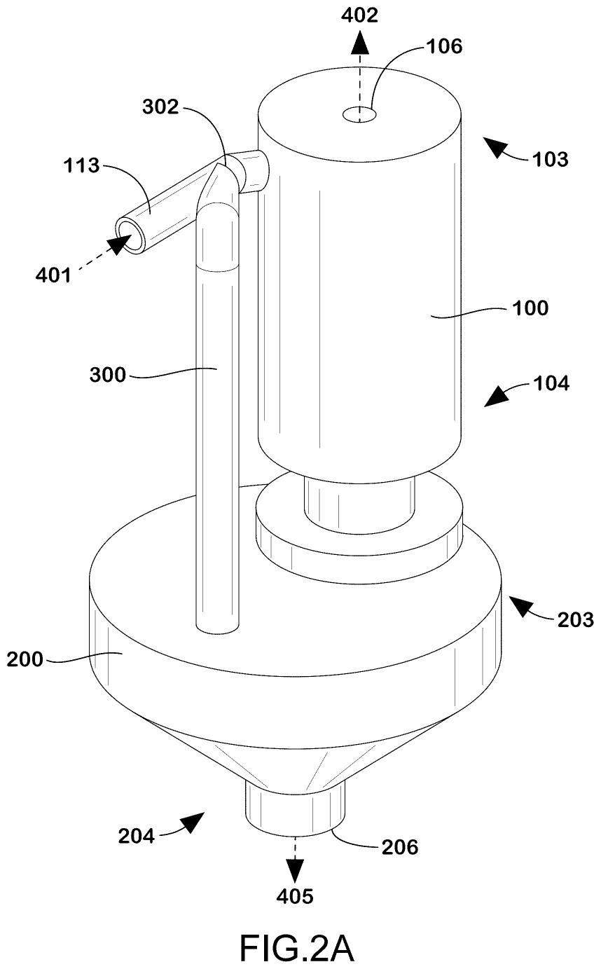

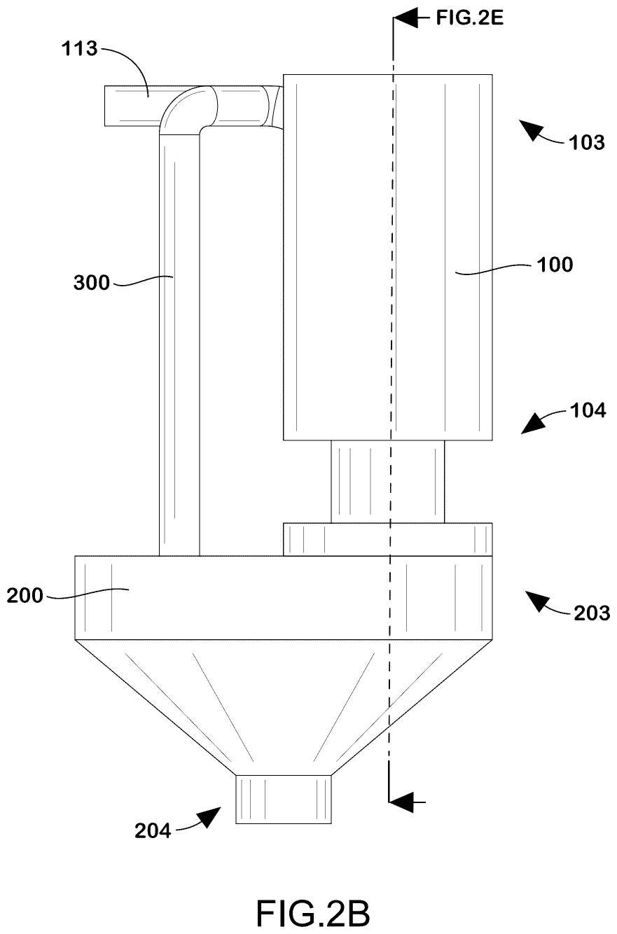

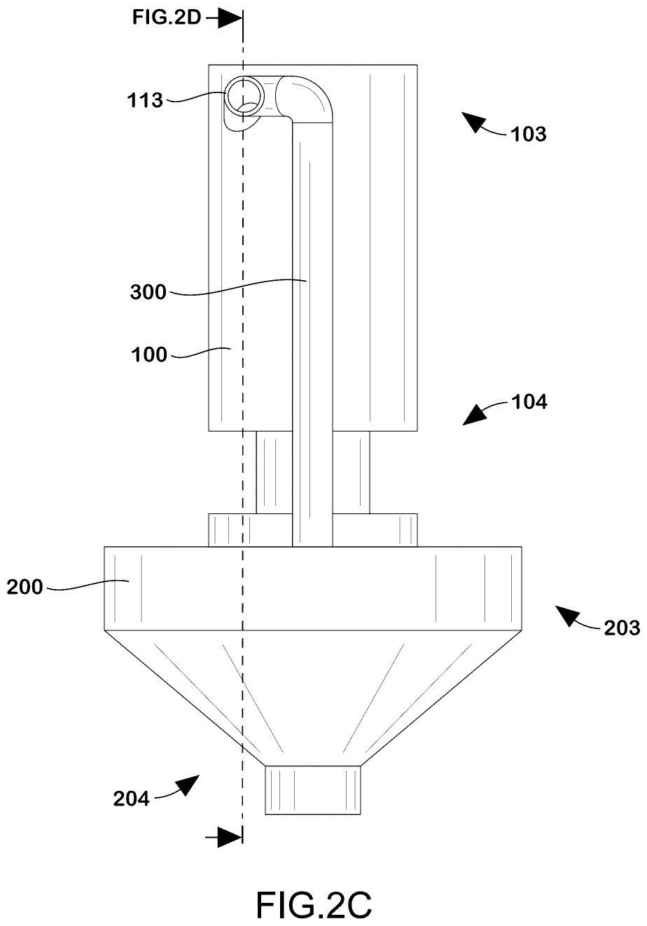

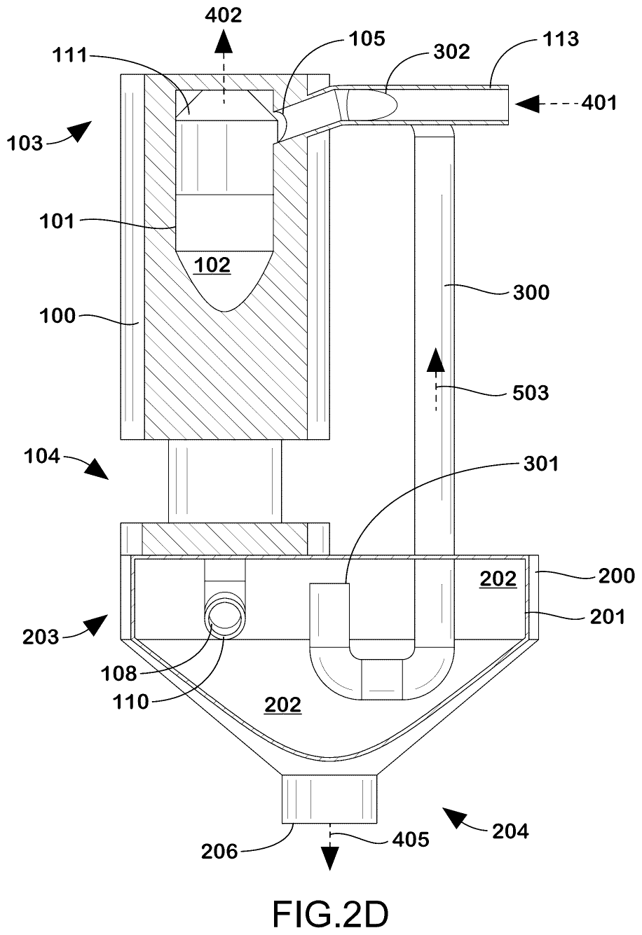

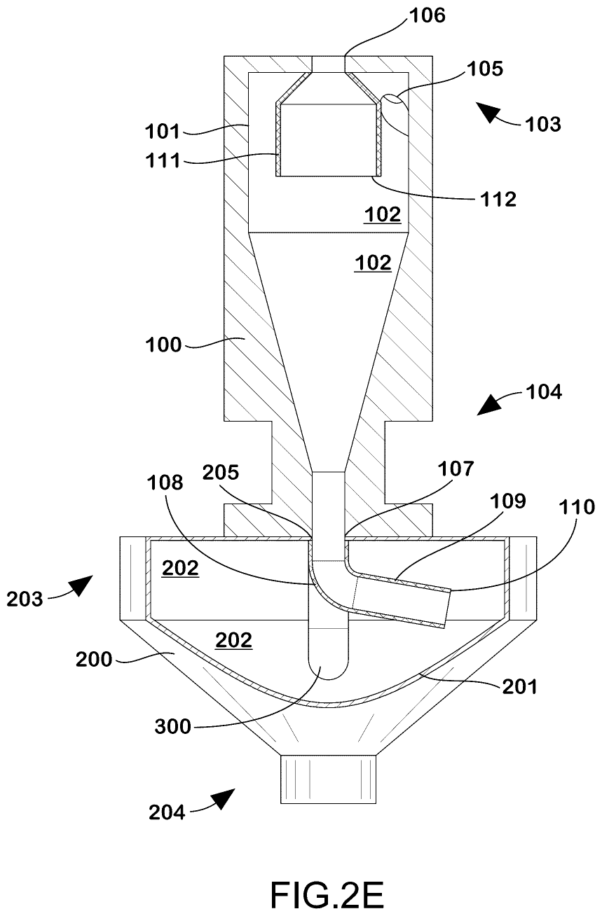

FIG. 2A-FIG. 2E depict a second illustrated embodiment of the separation system where the bypass conduit (300) merges with the process stream conduit (113) upstream of the primary separator (100). The bypass stream (403) exits the bypass outlet (302) and joins the process stream (401) before entering the primary enclosure.

### Tertiary Embodiment

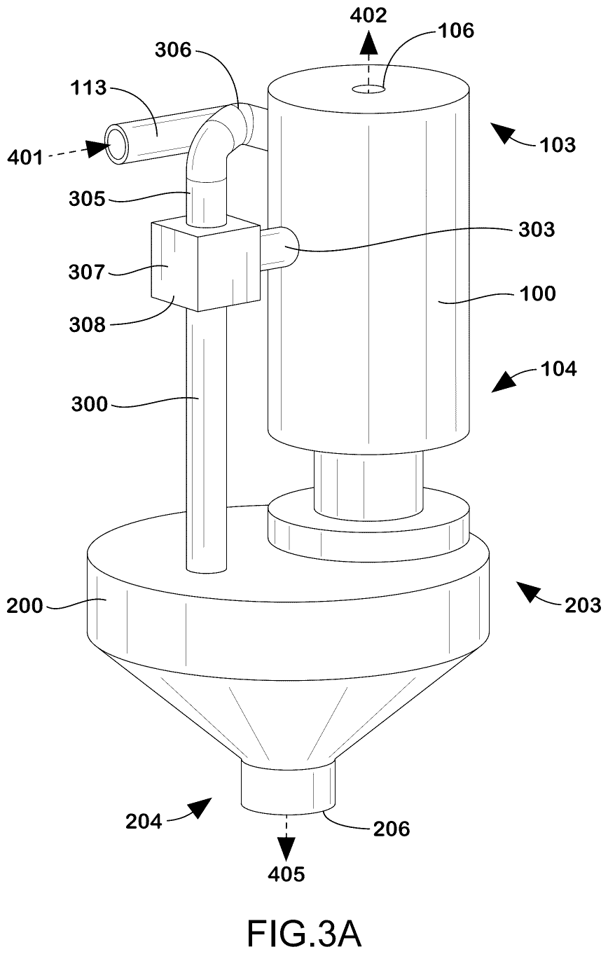

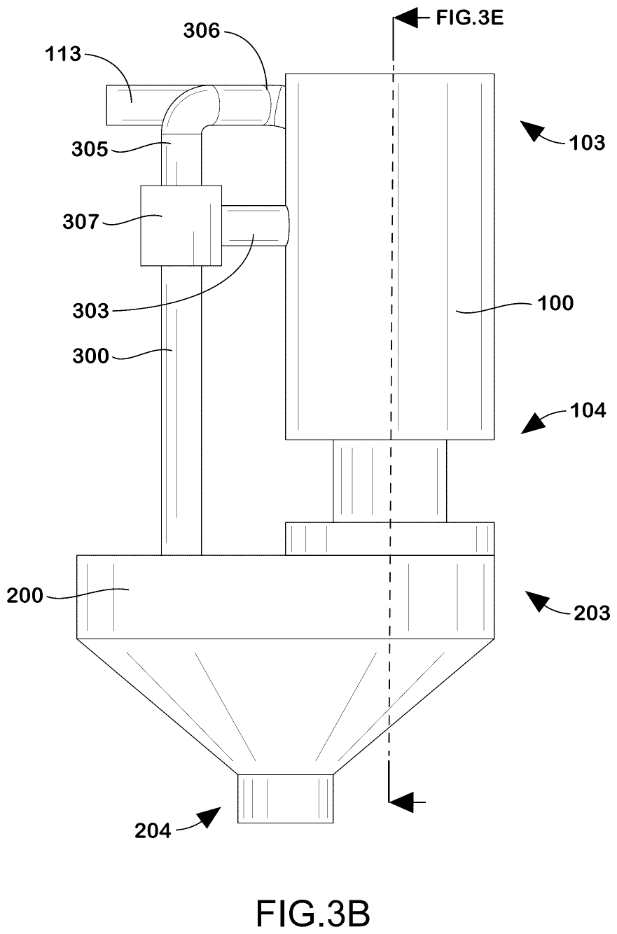

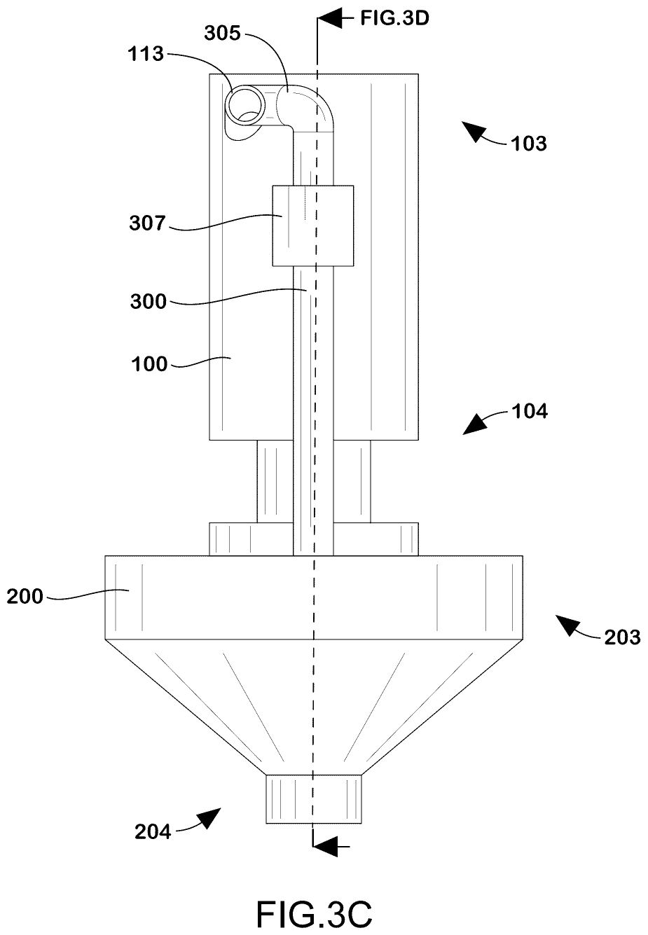

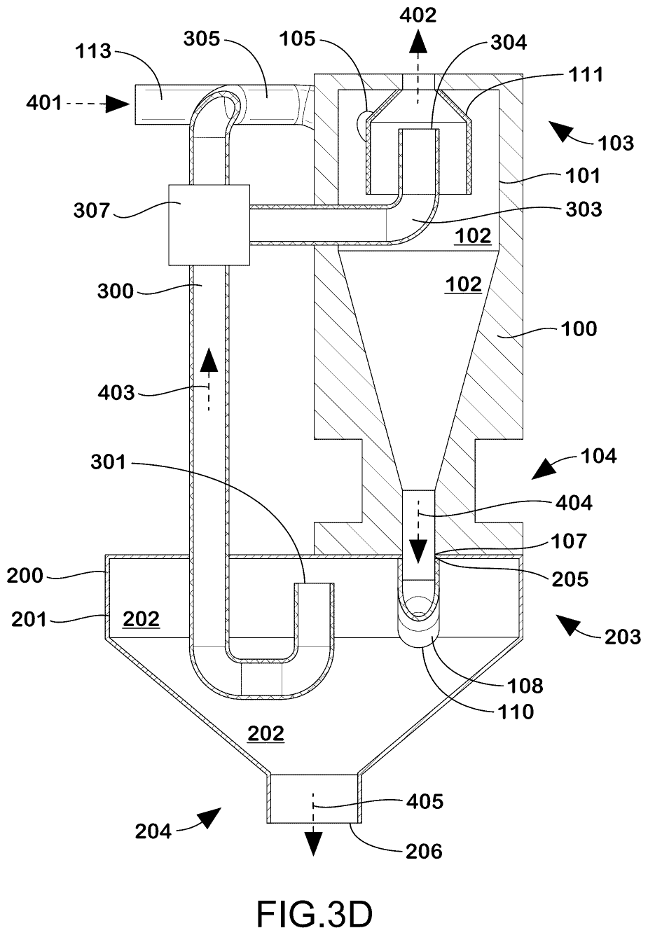

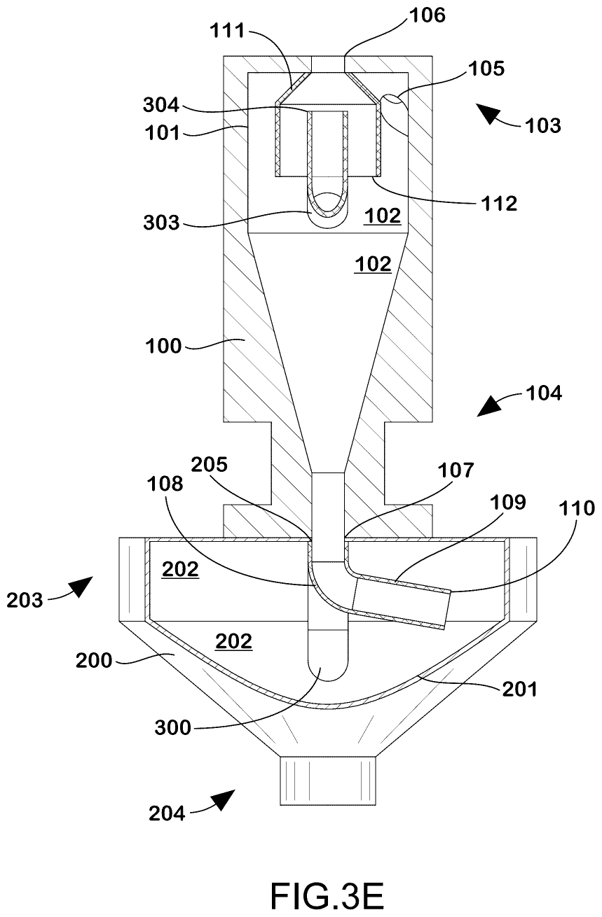

FIG. 3A-FIG. 3E depict a third illustrated embodiment of the separation system which may be thought of as a combination of the first and second illustrated embodiments. In the third illustrated embodiment, the bypass conduit passes through a splitting valve (307). The splitting valve is configured to direct the bypass stream through the interior bypass branch (303) or the exterior bypass branch (305). In this embodiment, the splitting valve is a splitting check valve (308) which prevents backflow of the bypass stream. Other embodiments where the splitting valve is not a splitting check valve are contemplated. The interior bypass branch has an interior bypass outlet (304) which is disposed within the primary enclosure (100). The exterior bypass branch has an exterior bypass outlet (306) which merges with the process stream conduit (113) upstream of the primary separator. The splitting check valve may be configured to direct the bypass stream to the interior bypass branch or the exterior bypass branch based a variety of factors including but not limited to: the composition, pressure, or flowrate of the process stream, the desired separation efficiency, the desired composition of the filtered stream (402), operational considerations, etc.

### Manufacturing

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### Feature List

Primary Separator (100)
Primary Enclosure (101)
Lateral Wall (102)
Upper End (103)
Lower End (104)
Primary Inlet (105)
Filtered Outlet (106)
Primary Outlet (107)
Primary Sand Conduit (108)
Primary Outlet Segment (109)
Primary Sand Conduit Outlet (110)
Isolation Shroud (111)
Bottom Opening (112)
Process Stream Conduit (113)
Secondary Separator (200)
Secondary Enclosure (201)
Lateral Wall (202)
Upper End (203)
Lower End (204)
Secondary Inlet (205)
Disposal Port (206)
Bypass Conduit (300)
Bypass Inlet (301)
Bypass Outlet (302)
Interior Bypass Branch (303)
Interior Bypass Outlet (304)
Exterior Bypass Branch (305)
Exterior Bypass Outlet (306)
Splitting Valve (307)
Splitting Check Valve (308)
Process Stream (401)
Filtered Stream (402)
Bypass Stream (403)
Primary Sand Stream (404)
Disposal Stream (405)

What is claimed is:

1. A cyclonic separation system that comprises of a primary separator and a secondary separator with a bypass conduit between the primary separator and secondary separator,
a. The primary separator comprises a primary enclosure with an inlet through which the process stream enters tangentially, a filtered outlet located at its top through which the filtered stream exits and a primary outlet at its bottom through which the primary sand stream exits towards the secondary separator,
b. The secondary separator comprising a secondary enclosure that receives the primary sand stream from the primary separator and disposes the settled sand through the disposal port,
c. The bypass conduit being a conduit configured to convey a bypass stream, the bypass conduit having a bypass inlet and a bypass outlet, the bypass inlet being disposed within the secondary enclosure, the bypass outlet being disposed within the primary enclosure.

2. The cyclonic separation system of claim 1, further comprising:
a. An isolation shroud, the isolation shroud having a bottom opening, the isolation shroud being attached to the upper end of the primary enclosure around the filtered outlet, the isolation shroud configured to partially isolate the bypass stream from the process stream entering the primary enclosure through the primary inlet.

3. A cyclonic separation system, the cyclonic separation system comprising a primary separator, a secondary separator, and a bypass conduit,
a. The primary separator comprises a primary enclosure with an inlet through which the process stream enters tangentially, a filtered outlet located at its top through which the filtered stream exits and a primary outlet at its bottom through which the primary sand stream exits towards the secondary separator,
b. The secondary separator comprising a secondary enclosure that receives the primary sand stream from the primary separator and disposes the settled sand through the disposal port,
c. The bypass conduit being a conduit configured to convey a bypass stream, the bypass conduit having a bypass inlet and a bypass outlet, the bypass inlet being disposed within the secondary enclosure, the bypass outlet merging directly or indirectly with the process stream upstream of the primary inlet.

4. A cyclonic separation system, the cyclonic separation system comprising a primary separator, a secondary separator, a bypass conduit,
a. The primary separator comprises a primary enclosure with an inlet through which the process stream enters tangentially, a filtered outlet located at its top through which the filtered stream exits and a primary outlet at its bottom through which the primary sand stream exits towards the secondary separator,
b. The secondary separator comprising a secondary enclosure that receives the primary sand stream from the primary separator and disposes the settled sand through the disposal port,
c. The bypass conduit being a conduit configured to convey a bypass stream, the bypass conduit having a bypass inlet, a splitting valve, an interior bypass branch with its outlet disposed within the primary separator, and an exterior bypass branch with its outlet merges with the process stream upstream of the primary inlet, the bypass inlet being disposed within the secondary enclosure, the splitting valve being disposed on the bypass conduit, the splitting valve configured to convey the bypass stream from the bypass inlet through either the interior bypass branch or the exterior bypass branch depending on the pressure difference between the primary inlet and the bypass inlet,
d. The splitting valve directs the bypass stream towards the interior bypass branch when pressure in primary inlet is higher than that at the bypass inlet while it directs the bypass stream towards the exterior bypass branch when the pressure in the primary inlet is lower than that at the bypass inlet.

5. The cyclonic separation system of claim 4, further comprising:
a. An isolation shroud, the isolation shroud having a bottom opening, the isolation shroud being attached to the upper end of the primary enclosure around the filtered outlet, the isolation shroud configured to partially isolate the bypass stream from the process stream entering the primary enclosure through the primary inlet.
